(19) United States
(12) Patent Application Publication
(10) Pub. No.: US 2003/0085993 A1
(43) Pub. Date: May 8, 2003

(54) Tuneable secondary audio program receiver

(76) Inventors: Robert S. Trimbee, Enniskillen (CA); John C. Stubbs, Mississauga (CA)

Correspondence Address: Baker McLachlen, P.O. Box 2780, Station D, Ottawa, ON, K1P 5W8, CA

(21) Appl. No.: 10/284,162

(22) Filed: Oct. 31, 2002

Related U.S. Application Data
(60) Provisional application No. 60/330,876, filed on Nov. 1, 2001.

(51) Int. Cl. H04N 9/47; H04N 5/44

(52) U.S. Cl. 348/62; 348/561

(57) ABSTRACT

An S.A.P. receiver is provided which does not require a conventional television set to obtain the S.A.P. audio. A tuner is coupled to an S.A.P. decoder and the audio program is output to the user. Thus blind and sight-impaired persons can receive S.A.P. programming without having to purchase a complete television receiver that relies on a user's ability to see alphanumeric on-screen menus.

This application relates to U.S. application Serial No. 60/330,876 filed Nov. 1, 2001.

### FIELD OF THE INVENTION

The present invention relates to the field of useful devices for vision impaired persons, and in particular, audio receivers for receiving the secondary audio program available from television programs.

### BACKGROUND OF THE INVENTION

A secondary audio program (S.A.P.) service is carried within a television transmission as an alternative to the standard audio that accompanies the video portion of a program. The listener may choose this secondary audio signal. A TV station can broadcast other information to the listener, such as a second-language audio signal or a sound track with descriptive audio information for the sight impaired. Video descriptions on the S.A.P. help blind and vision impaired listeners follow the on-screen action of a television program by providing information that is not obvious from the original sound track. Alternatively, a stand-alone audio program, such as a reading service like VoicePrint™, a round-the-clock audio service produced by The National Broadcast Reading Service, can be delivered to 6.3 million homes via an S.A.P. facility. For a person with low or no vision, the cost of a TV receiver when only audio is required is an unnecessary expense. And its on-screen menu is impossible to access. What is required is a device that can receive a signal on the S.A.P. directly without a TV receiver.

Regulatory bodies in both Canada and the United States now require broadcasters to provide S.A.P.-based services such as Voiceprint or a described audio sound track to customers in many locations. Television broadcasters in both countries now are required to broadcast described programming during prime-time hours. In North America the described information is broadcast on the S.A.P. Video description rules require TV licensees and program distributors to include 50 hours of described programming per calendar quarter.

What now is required by blind and sight impaired viewers to access the described information and other special audio services is a tuneable, inexpensive and easy-to-use S.A.P. access device that can be operated without a reliance on controls that sighted viewers use to tune a specific TV channel or a S.A.P.-based service such as a second-language audio signal distributed on the S.A.P. feature of a television transmission.

### STATEMENT OF THE INVENTION

The present invention provides a unique and tuneable S.A.P. access unit that enables blind and vision impaired persons to tune to a TV channel of choice and to receive S.A.P. program signals. Such an access device costs a fraction of the price of a regular TV set and provides access to all available programming that can be received in a particular area. In one embodiment, the S.A.P. access device comprises a cable connector, TV tuner chip, an IF and video detector, an S.A.P. demodulator and audio output. A micro-controller with an optional display and a voice chip controls the operation of the receiver. In an alternative embodiment, the S.A.P. access unit comprises a preset macro programmable remote control, a video cassette recorder (VCR) having an audio output and a multi-media speaker system. The VCR is controlled by the macro programmable remote control, and the user can obtain the required programming by using a tactile key pad to access the appropriate TV channel and then clicking a single button on the control.

### BRIEF DESCRIPTION OF THE DRAWINGS

FIG. 1 is a block diagram of a first embodiment of the S.A.P access unit;

FIG. 2 is a front view of the S.A.P. receiver of FIG. 1 with speakers on either side of the unit;

FIG. 3 is a schematic diagram of the input circuit of FIG. 1;

FIG. 4 is a schematic diagram of an FM receiver of FIG. 1;

FIG. 5 is a schematic diagram of the S.A.P demodulator of FIG. 1;

FIG. 6 is a schematic diagram of the multiplexer (MUX) of FIG. 1;

FIG. 7 is a schematic diagram of the IF and Video detector of FIG. 1;

FIG. 8 is a schematic diagram of the micro controller of FIG. 1;

FIG. 9 is a schematic diagram of the voice generator of FIG. 1;

FIG. 10 is a schematic diagram of the display board of FIG. 1, and

FIG. 11 is a block diagram of a second embodiment of the S.A.P. receiver of the invention.

### DETAILED DESCRIPTION OF THE PREFERRED EMBODIMENTS

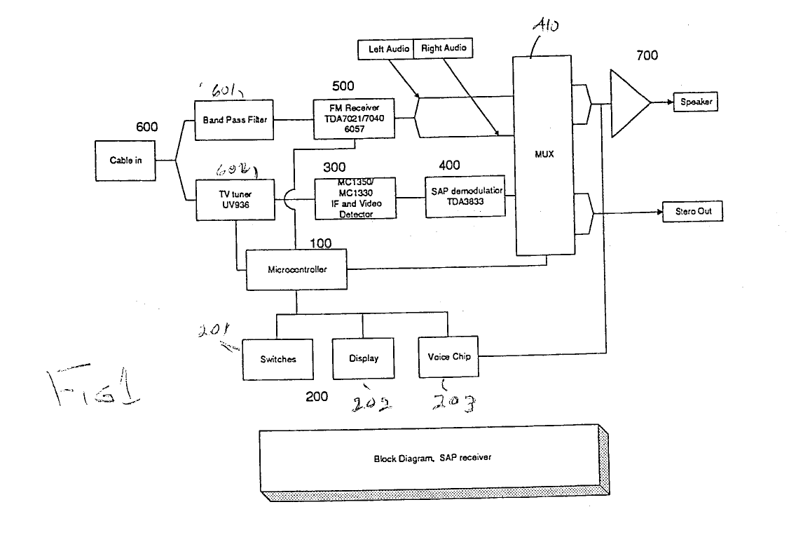

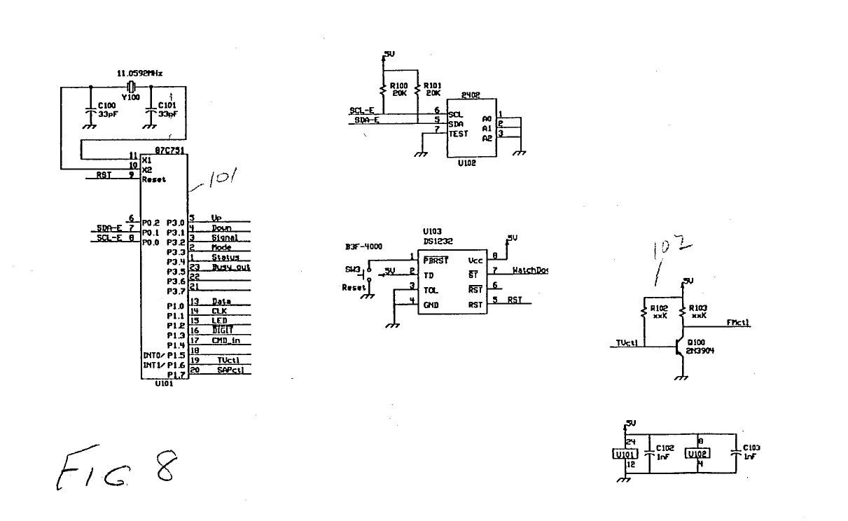

FIG. 1 is a block diagram of a first embodiment of the invention, intended to work from a TV cable or other source of RF TV signals. A cable-in module (600) receives the signal and feeds it to a band-pass filter (601), and to a TV tuner (602). From the band-pass filter, the signal is fed to FM receiver (500). If FM signals are not required, the band-pass filter (601), and FM receiver (500) can be omitted from the unit, with a corresponding saving in cost. From the TV tuner (602), the signal is fed to the IF and video detector (300). The S.A.P. demodulator (400) is connected to the output of the unit (300), and feeds the secondary audio program to the multiplexer (410). The S.A.P. receiver is operated by switches (201), which also operate the display (202), and the voice chip (203). The voice chip (203) sends an audio signal to the speaker (700), indicating the function selected by the switches (201). FM left and right signals, TV left and right signals, S.A.P. audio and voice chip signals are fed to the multiplexer (410) and are passed to amplifiers and stereo equipment as required, as shown in FIG. 7, and described below.

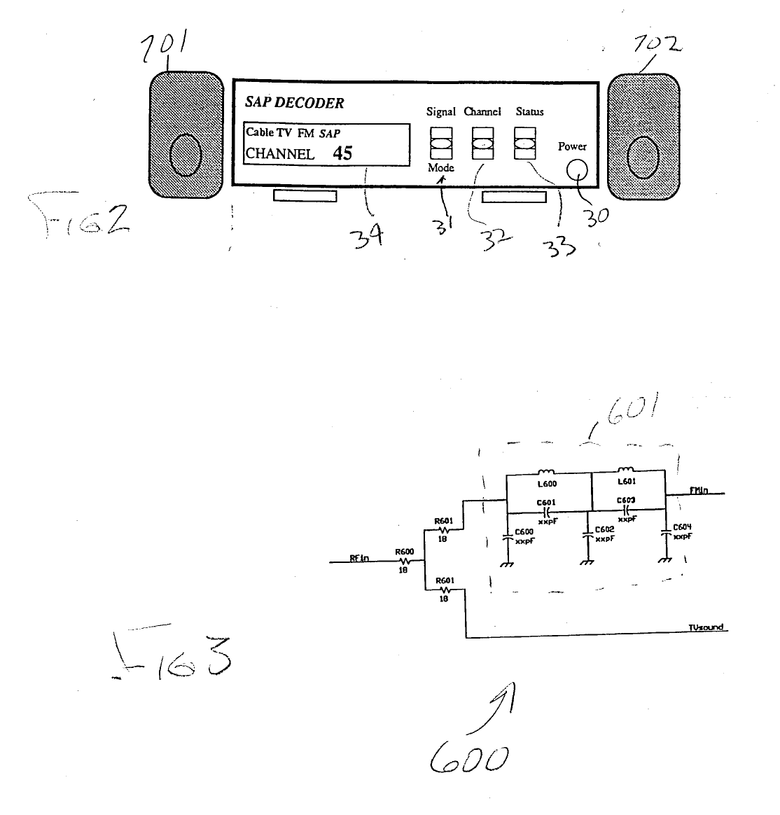

FIG. 2 illustrates the front panel and speakers of the embodiment of FIG. 1. Not shown are connectors for cable and aerial antenna, which would in the usual way be located on the rear of the unit. The controls (201) are: a power switch (30) preferably a push button spring type, a signal mode selector (31) preferably an up/down centre off switch, a channel selector up/down switch (32), and a status announcement button (33). A status panel including LED readout shows the channel in a 4 digit numeric display, and a combination LED displays Cable TV/FM/S.A.P. Speakers (701) and (702) are shown on either side of the unit.

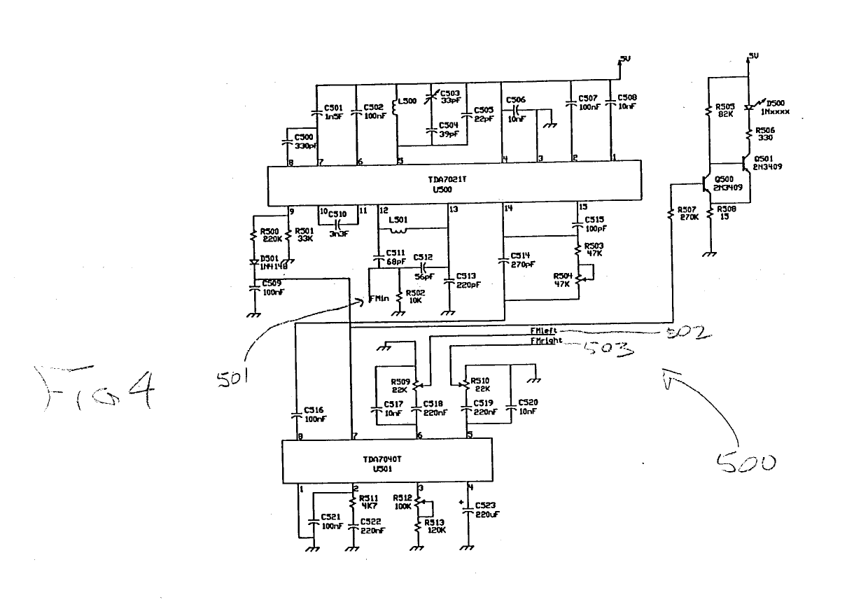

FIG. 3 in schematic form shows the input circuit (600) of the unit (200) including the band-pass filter (601), and the outputs for the FM receiver (500) and for the TV tuner (602). The components and values are chosen to provide the required separation and band-pass required for the FM and TV inputs, which are within the ordinary skill of a circuit designer.

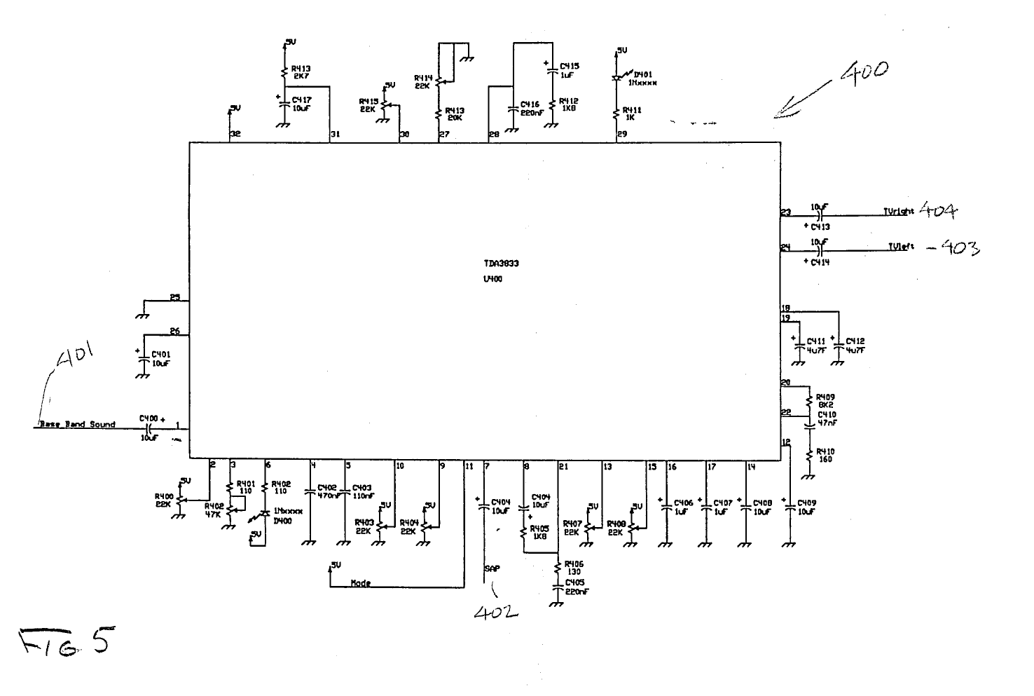

FIG. 4 is a schematic diagram of the FM receiver (500) of FIG. 1. The circuit is provided with 5 volt DC power and two ICs are used, a TDA7021T and TDA7040T. The output from the band-pass filter (601) of FIG. 3 is received at FM-in (501) at pin 12 of TDA7021T, and is converted to FM left and FM right audio signals (502) and (503), respectively.

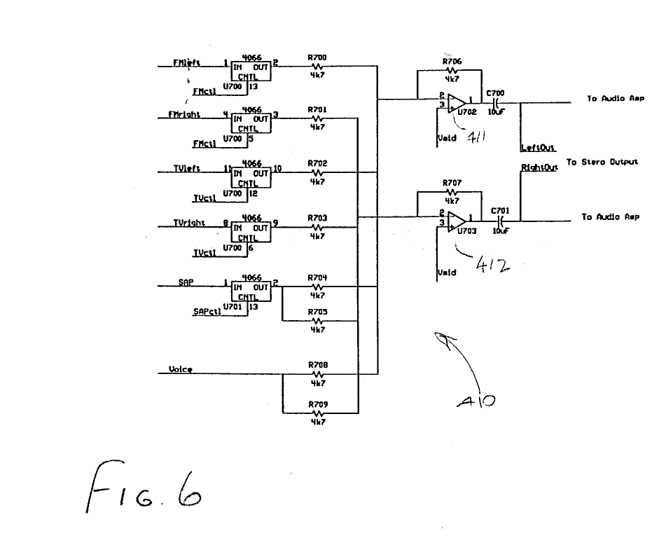

FIG. 5 is the S.A.P. decoder, or demodulator (400), which receives the base band Audio at (401) from the from the IF and video Detector (300) of FIG. 1 and outputs the S.A.P. audio at (402) and the TV left and right sound at (403) and (404), respectively. The signal processing is performed by the IC TDA3833.

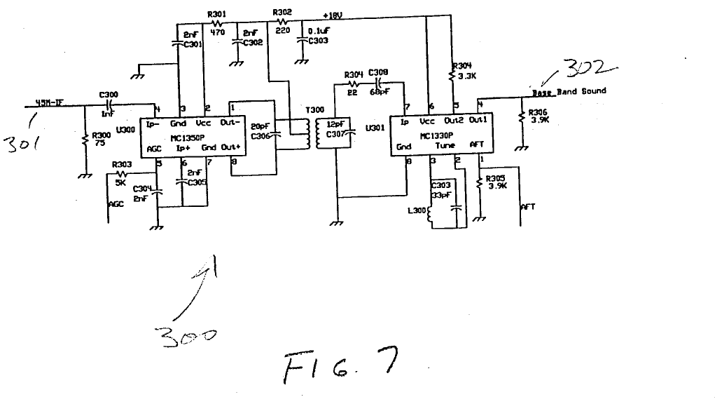

FIG. 6 is a schematic of the multiplexer (410) of FIG. 1, which is controlled by the micro controller (100) of FIG. 1. Audio inputs FM left, FM right, TV left, TV right, S.A.P. and voice from the voice chip (203) are passed to the outputs Left Out, Right Out and to Audio Amp, under control of signals FM ctl,TVctl, S.A.P.ctl, and voice from the micro controller (100). Suitable amplifiers (411) and (412) amplify the outputs of the MUX (410) as required.

FIG. 7 is a schematic of the IF and video detector (300) of FIG. 1. Ics MC1350P and MC1330P receive and amplify the IF input at (301), and output the base band audio at (302) which is input to the S.A.P. demodulator (400). Component values as illustrated are chosen for the desired operation of the circuit and are within the scope of the circuit designer.

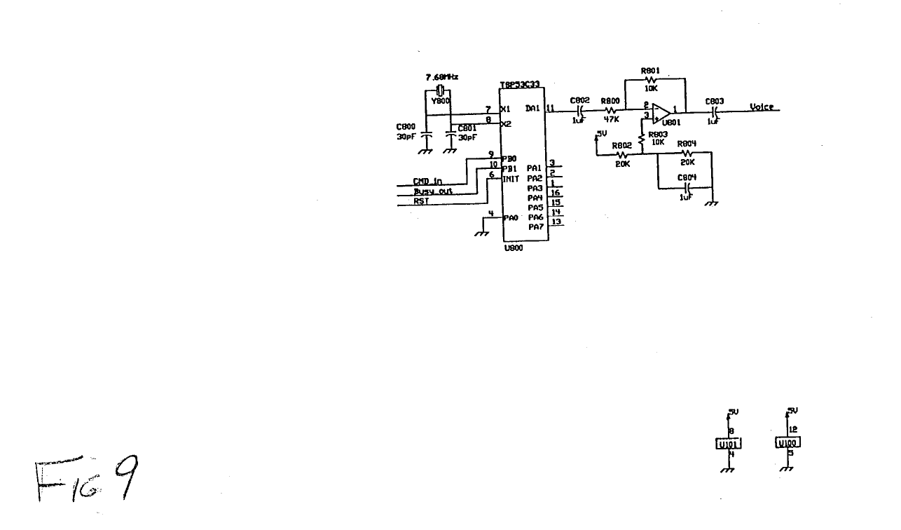

FIG. 8 is a schematic diagram of the micro controller (100). An IC (101) shown as 87C51 provides control signals to all components of the unit as required. TV control signal (TVctl) is output at pin 19 of the IC and through circuit (102) toggles between TV and FM signals being fed to the MUX (410). Similarly, the S.A.P. signal at pin 20 of IC (101) controls the output of S.A.P. demodulator and passes S.A.P. audio at pin 402 of unit (400) (FIG. 5). Once again the selection of specific components is within the skill of a circuit designer.

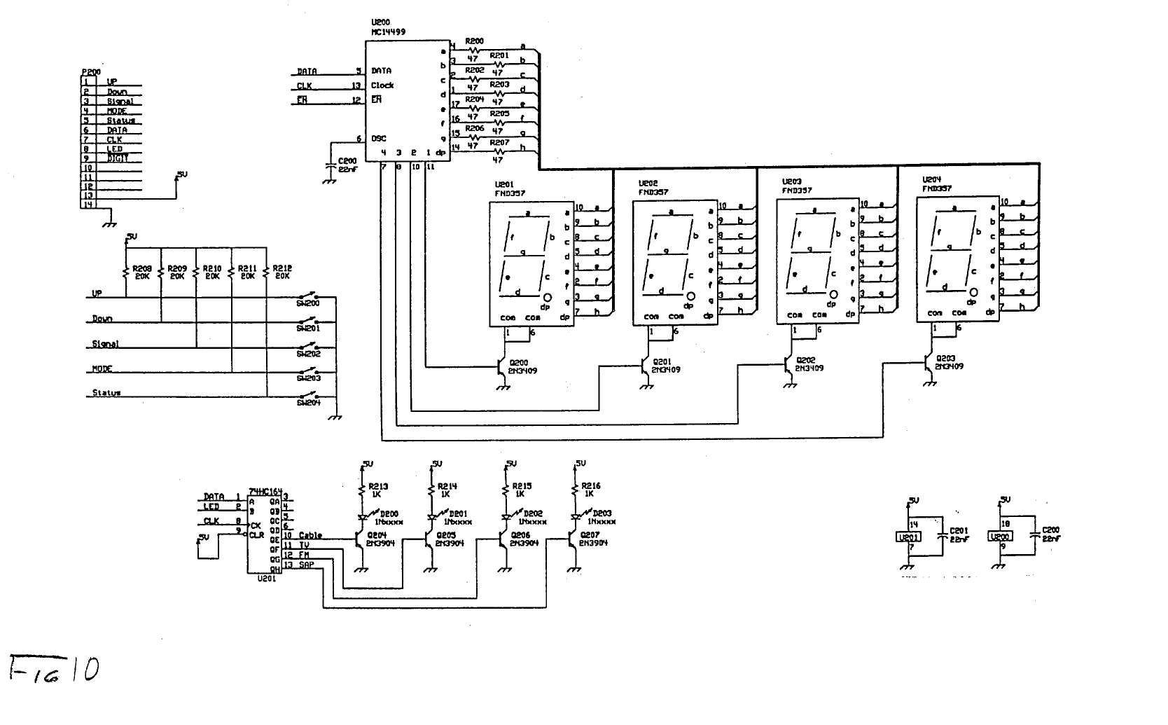

FIG. 9 is a schematic circuit of the voice chip (203) of FIG. 1. An IC TSP53C33 generates voice signals under command of the micro controller (100), which are fed to the MUX (410) and to the output (700).

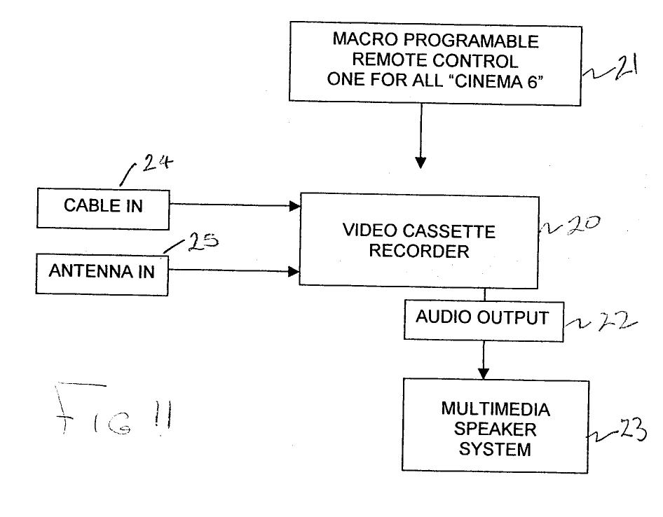

FIG. 10 illustrates a schematic for the display board (34) of FIG. 2. A series of LED symbols are shown together with the drivers and control circuits.

Table 1 below illustrates component values and
specifications for the components of FIGS. 1 to 11.

| QTY | Description | Value | P/N | DigiKey P/N |
|---|---|---|---|---|
| SAP main board Part list (NO FM receiver) | | | | Oct. 17, 2001 16:54 |
| 2 | Resistor, 5% 1/4 W | 10 | 1/4 Watts 5% Carbon Film | QBK-BD |
| 3 | Resistor, 5% 1/4 W | 27 | 1/4 Watts 5% Carbon Film | QBK-BD |
| 1 | Resistor, 5% 1/4 W | 130 | 1/4 Watts 5% Carbon Film | QBK-BD |
| 1 | Resistor, 5% 1/4 W | 160 | 1/4 Watts 5% Carbon Film | QBK-BD |
| 1 | Resistor, 5% 1/4 W | 180 | 1/4 Watts 5% Carbon Film | QBK-BD |
| 2 | molded RF coils | 0.12 uH | Delevan, 1641-121j | DN41121-ND |
| 3 | Ceramic Capacitor, radial | 0.1 uF 63 V | Panasonic ECU-S1J104KBB | P4887-ND |
| 1 | Ceramic Capacitor, radial | 0.47 uF 63 V | Panasonic ECU-S1J474MEB | P4919-ND |
| 1 | Elect. Capacitor, radial | 1000 uF_63 V | Panasonic ECE-B1JGE102 | P5490-ND |
| 1 | Volumn Control Pot, with ON/OFF | 100K | | CT2219-ND |
| 1 | Power Inductor | 100 uH | Delevan, 2474-25L | DN7425-ND |
| 8 | Ceramic Capacitor, radial | 10 n 63 V | Panasonic ECU-S1J103KBA | P4904-ND |
| 13 | Elect. Capacitor, radial | 10 uF_16 V | Panasonic ECE-A16Z10 | P6616-ND |
| 1 | Terminal Post | 11 contacts | | WN4009-ND |
| 1 | Resistor, 5% 1/4 W | 110K | 1/4 Watts 5% Carbon Film | QBK-BD |
| 1 | Wall Transformer | 12 V 800 mA | Cui DPD120080-P-5 | T507-ND |
| 2 | Resistor, 5% 1/4 W | 1K | 1/4 Watts 5% Carbon Film | QBK-BD |
| 2 | Resistor, 5% 1/4 W | 1K8 | 1/4 Watts 5% Carbon Film | QBK-BD |
| 1 | Resistor, 5% 1/4 W | 1K8 | 1/4 Watts 5% Carbon Film | QBK-BD |
| 1 | Silicon Diode | 1N4002 | | 1N4002CT-ND |
| 1 | Shottky Diode | 1N5819CT | | 1N5819CT-ND |
| 6 | Ceramic Capacitor, radial | 1 nF 63 V | Panasonic ECU-S1J102JCB | P4812-ND |
| 16 | Tantalum. Capacitor, radial | 1 uF_16 V | Panasonic ECS-F1CE105K | P2105-ND |
| 8 | Terminal Post | 2 contacts | | WN4000-ND |
| 3 | Resistor, 5% 1/4 W | 20K | 1/4 Watts 5% Carbon Film | QBK-BD |
| 2 | Ceramic Capacitor, radial | 220 n 63 V | Panasonic ECU-S1J224KBB | P4889-ND |
| 3 | Resistor, 5% 1/4 W | 22K | 1/4 Watts 5% Carbon Film | QBK-BD |
| 7 | Trimmer, Multiturn | 25K | | 3299W-253-ND |
| 1 | Resistor, 5% 1/4 W | 2k2 | 1/4 Watts 5% Carbon Film | QBK-BD |
| 1 | Resistor, 5% 1/4 W | 2K7 | 1/4 Watts 5% Carbon Film | QBK-BD |
| 2 | Terminal Post | 3 contacts | | WN4001-ND |
| 2 | Ceramic Capacitor, radial | 39 pF 100 V | Panasonic ECU-S2A3390JCA | P4844-ND |
| 12 | Resistor, 5% 1/4 W | 4.7K | 1/4 Watts 5% Carbon Film | QBK-BD |
| 4 | Resistor, 5% 1/4 W | 4.7K | 1/4 Watts 5% Carbon Film | QBK-BD |
| 2 | Elect. Capacitor, radial | 470 uF_25 V | Panasonic ECS-A1VGE471 | P5260-ND |
| 1 | Ceramic Capacitor, radial | 47 nF 63 V | Panasonic ECU-S1J473KBB | P4885-ND |
| 2 | Elect. Capacitor, radial | 4u7F_35 V | Panasonic ECS-A1VGE4R7 | P5252-ND |
| 1 | Terminal Post | 5 contacts | | WN4003-ND |
| 1 | Trimmer, Multiturn | 50K | | 3299W503-ND |
| 1 | Resistor, 5% 1/4 W | 56K | 1/4 Watts 5% Carbon Film | QBK-BD |
| 1 | RF coils | 56 nH | Panasonic ELJ-ND56NJF | PCD1169CT-ND |
| 2 | Ceramic Capacitor, radial | 56 pF 100 V | Panasonic ECU-S2A560JCA | P4846-ND |
| 1 | Resistor, 5% 1/4 W | 75K | 1/4 Watts 5% Carbon Film | QBK-BD |
| 1 | Voltage Regulator | 78M12 | | |
| 1 | Resistor, 5% 1/4 W | 8K2 | 1/4 Watts 5% Carbon Film | QBK-BD |
| 1 | Phillips, RF Tuner | FR1236 | | |
| 1 | Switch Mode Voltage Controller | LM2575T-50 | | |
| 1 | Speaker amp | MC34119 | | |
| 3 | Resistor, 5% 1/4 W | TBD | 1/4 Watts 5% Carbon Film | QBK-BD |
| 1 | TV Sound Process | TDA3833 | | |
| 1 | Op Amp | TL082 | JFET OP-Amp, DIP | |
| 3 | Ceramic Capacitor, radial | xxpF | Optional | |
| 5 | LED | | High Efficiency RED LED | HLMP-1700QT-ND |
| 1 | Coaxial Power Jack, 2.0 MM | | PJ-002A | CP002A-ND |
| 1 | Slide Siwtch, SPDT | | C&K 1101M2S3ABE2 | CKN5005-ND |
| 2 | Analog Siwtch | | CD4066BE | CD4066BE-ND |
| 1 | Plastic Enclosure | | 6.32″ × 8.10″ × 2.52″ | |
| 1 | Stero Jack, ⅛ in dia. panel Mount | | | CP-3505-ND |
| 1 | Interconnect Cable | | | |
| 1 | Speaker, 2.2″ | | | |
| 1 | Knobes | | | |
| 2 | Type F connector, RCA cable | | | |
| 4 | Switch. momentary, spst | | | CKN4051-ND |
| 1 | Nuts, #4 | | | |
| 1 | Screws #4 | | | |
| 1 | Switch. momentary, spst | | | CKN4051-ND |
| 1 | Switch. momentary, spst | | | CKN4051-ND |
| 1 | Switch. momentary, spst | | | CKN4051-ND |
| 1 | Type F connector, RCA cable | | | |
| 1 | PCB, Main board | | | |
| SAP display board Part list | | | | Oct. 17, 2001 17:01 |
| C101 | Ceramic Capacitor, radial | 39 pF 100 V | Panasonic ECU-S2A3390JCA | P4844-ND |
| C102 | Ceramic Capacitor, radial | 39 pF 100 V | Panasonic ECU-S2A3390JCA | P4844-ND |
| C103 | Ceramic Capacitor, radial | 1 nF 63 V | Panasonic ECU-S1J102JCB | P4812-ND |
| C104 | Ceramic Capacitor, radial | 1 nF 63 V | Panasonic ECU-S1J102JCB | P4812-ND |
| C108 | Ceramic Capacitor, radial | 39 pF 100 V | Panasonic ECU-S2A3390JCA | P4844-ND |
| C109 | Ceramic Capacitor, radial | 39 pF 100 V | Panasonic ECU-S2A3390JCA | P4844-ND |
| C110 | Tantalum. Capacitor, radial | 1 uF_16 V | Panasonic ECS-F1CE105K | P2105-ND |
| C111 | Tantalum. Capacitor, radial | 1 uF_16 V | Panasonic ECS-F1CE105K | P2105-ND |
| C112 | Tantalum. Capacitor, radial | 1 uF_16 V | Panasonic ECS-F1CE105K | P2105-ND |
| C113 | Ceramic Capacitor, radial | 22 nF | Panasonic ECU-S1J223KBA | P4884-ND |
| C114 | Elect. Capacitor, radial | 10 uF_16 V | Panasonic ECE-A16Z10 | P6616-ND |
| C115 | Ceramic Capacitor, radial | 10 n 63 V | Panasonic ECU-S1J103KBA | P4904-ND |
| C116 | Elect. Capacitor, radial | 10 uF_16 V | Panasonic ECE-A16Z10 | P6616-ND |
| C118 | Ceramic Capacitor, radial | 1 nF 63 V | Panasonic ECU-S1J102JCB | P4812-ND |
| D100 | LED, Red | | High Efficiency RED LED | HLMP-1700QT-ND |
| D101 | LED, Red | | High Efficiency RED LED | HLMP-1700QT-ND |
| D102 | LED, Red | | High Efficiency RED LED | HLMP-1700QT-ND |
| D103 | LED, Red | | High Efficiency RED LED | HLMP-1700QT-ND |
| D104 | LED, Red | | High Efficiency RED LED | HLMP-1700QT-ND |
| P1 | Terminal Post | 11 contacts | | ED7211-ND |
| P2 | Terminal Post | 3 contacts | | ED7203-ND |
| P3 | Terminal Post | 6 contacts | | ED7206-ND |
| Q100 | NPN Transistor | 2N3904 | | 2N3904-ND |
| Q101 | NPN Transistor | 2N3904 | | 2N3904-ND |
| Q102 | NPN Transistor | 2N3904 | | 2N3904-ND |
| Q103 | NPN Transistor | 2N3904 | | 2N3904-ND |
| Q104 | NPN Transistor | 2N3904 | | 2N3904-ND |
| Q105 | NPN Transistor | 2N3904 | | 2N3904-ND |
| Q106 | NPN Transistor | 2N3904 | | 2N3904-ND |
| Q107 | NPN Transistor | 2N3904 | | 2N3904-ND |
| R100 | Resistor, 5% 1/4 W | 4K7 | 1/4 Watts 5% Carbon Film | QBK-BD |
| R101 | Resistor, 5% 1/4 W | 100K | 1/4 Watts 5% Carbon Film | QBK-BD |
| R102 | Resistor, 5% 1/4 W | 20K | 1/4 Watts 5% Carbon Film | QBK-BD |
| R103 | Resistor, 5% 1/4 W | 10K | 1/4 Watts 5% Carbon Film | QBK-BD |
| R104 | Resistor, 5% 1/4 W | 20K | 1/4 Watts 5% Carbon Film | QBK-BD |
| R105 | Resistor, 5% 1/4 W | 20K | 1/4 Watts 5% Carbon Film | QBK-BD |
| R106 | Resistor, 5% 1/4 W | 20K | 1/4 Watts 5% Carbon Film | QBK-BD |
| R107 | Resistor, 5% 1/4 W | 20K | 1/4 Watts 5% Carbon Film | QBK-BD |
| R108 | Resistor, 5% 1/4 W | 20K | 1/4 Watts 5% Carbon Film | QBK-BD |
| R109 | Resistor, 5% 1/4 W | 20K | 1/4 Watts 5% Carbon Film | QBK-BD |
| R110 | Resistor, 5% 1/4 W | 20K | 1/4 Watts 5% Carbon Film | QBK-BD |
| R111 | Resistor, 5% 1/4 W | 20K | 1/4 Watts 5% Carbon Film | QBK-BD |
| R112 | Resistor, 5% 1/4 W | 47 | 1/4 Watts 5% Carbon Film | QBK-BD |
| R113 | Resistor, 5% 1/4 W | 47 | 1/4 Watts 5% Carbon Film | QBK-BD |
| R114 | Resistor, 5% 1/4 W | 47 | 1/4 Watts 5% Carbon Film | QBK-BD |
| R115 | Resistor, 5% 1/4 W | 47 | 1/4 Watts 5% Carbon Film | QBK-BD |
| R116 | Resistor, 5% 1/4 W | 47 | 1/4 Watts 5% Carbon Film | QBK-BD |
| R117 | Resistor, 5% 114 W | 47 | 1/4 Watts 5% Carbon Film | QBK-BD |
| R118 | Resistor, 5% 1/4 W | 47 | 1/4 Watts 5% Carbon Film | QBK-BD |
| R119 | Resistor, 5% 1/4 W | 47 | 1/4 Watts 5% Carbon Film | QBK-BD |
| R120 | bare wire | 0 | | |
| R121 | bare wire | 0 | | |
| R122 | bare wire | 0 | | |
| R123 | bare wire | 0 | | |
| R124 | Resistor, 5% 1/4 W | 510 | 1/4 Watts 5% Carbon Film | QBK-BD |
| R125 | Resistor, 5% 1/4 W | 510 | 1/4 Watts 5% Carbon Film | QBK-BD |
| R126 | Resistor, 5% 1/4 W | 510 | 1/4 Watts 5% Carbon Film | QBK-BD |
| R127 | Resistor, 5% 1/4 W | 510 | 1/4 Watts 5% Carbon Film | QBK-BD |
| R128 | Resistor, 5% 1/4 W | 1K | 1/4 Watts 5% Carbon Film | QBK-BD |
| U100 | Microcontroller | | 87C751 | |
| U101 | EEPROM | | MC24C16 | |
| U102 | Voice Chip | | TSP53C33 | |
| U103 | Op AMP | TL-082 | JFET OP-Amp, DIP | |
| U104 | Micro Monitor | | DS1232 | |
| U105 | Serial Latch | | 74HC164 | |
| U106 | LED decoder | | MC14499 | |
| U107 | 7 segments Display | | FND357 | |
| U108 | 7 segments Display | | FND357 | |
| U109 | 7 segments Display | | FND357 | |
| U110 | 7 segments Display | | FND357 | |
| U112 | microcontroller, optional | | AT89C2051 | |
| Y100 | Crystal | 11.0592 MHz | | |
| Y101 | Crystal | 7.68 MHz | | |
| | 16 pins IC Socket | | | ED3116-ND |
| | 8 pins IC Socket | | | ED31-8-ND |
| | 24 pins IC Socket, 0.300 in wide | | | ED3124-ND |
| | PCB, display board | | | |
| | | | | US$ |

FIG. 11 is a block diagram of a second embodiment of the invention. In this embodiment, a VCR (20), which is controlled by a macro programmable remote control (21), such as that sold under the brand “One For All Cinema 6” provides a one button accessible S.A.P. access unit. The control (21) is programmed so that a single button is all that needs to be operated for obtaining an audio output (22), which can be fed to a multimedia speaker system (23). The VCR (20), is connected to cable or antenna inputs (24) and (25), and the desired TV channel is selected by pressing the appropriate tactile keys on the remote (21). The S.A.P. signal is then selected and output through the audio output (22) to the speaker system (23). A suitable VCR is a Sharp model VC-H960 HI-FT Stereo Video Cassette Recorder. The VCR used must be stereo and would therefore have S.A.P. capabilities.

We claim:

1. A secondary audio program (S.A.P.) receiver for blind and vision impaired persons, for receiving, decoding and outputting the S.A.P. audio attached to a television program, comprising means for receiving the television signals, means for selecting a television channel from a plurality of television channels, means for decoding the S.A.P. audio from the selected television channel, and means for identifying to blind or vision impaired users the identification of the selected television channel, and speaker means for presenting the S.A.P. or regular TV to the user.

2. An S.A.P. receiver as defined in claim 1 wherein said means for identifying the selected channel comprises a voice synthesizer connected to said speaker means.

3. An S.A.P. receiver as claimed in claim 1, including switching means for selecting channels, having a switch with up/down and centre positions for indicating the direction in which the channel tuning is being increased or decreased.

4. An S.A.P. receiver comprising means for connecting to a source of television programming, a channel tuning device, an IF and video detector, an S.A.P. demodulator and an audio output.

5. An S.A.P. receiver comprising a pre-programmed macro programmable one button remote control, a stereo video cassette recorder (VCR) having an audio output, means for connecting said VCR to a source of television programs, and a multi-media speaker system connected to said VCR, wherein the remote control is programmed to tune said VCR to selected channels, and to decode S.A.P. audio from a selected channel and provide an audio output to said speaker system of said S.A.P. audio.
